(19) United States
(12) Patent Application Publication
(10) Pub. No.: US 2008/0313430 A1
(43) Pub. Date: Dec. 18, 2008

(54) METHOD AND SYSTEM FOR INCREASING QUANTUM COMPUTER PROCESSING SPEED USING DIGITAL CO-PROCESSOR

(76) Inventor: Paul I. Bunyk, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 12/138,292

(22) Filed: Jun. 12, 2008

Related U.S. Application Data
(60) Provisional application No. 60/943,525, filed on Jun. 12, 2007.

(51) Int. Cl. G06F 15/76; G06F 9/32

(52) U.S. Cl. 712/34; 712/E09.082

(57) ABSTRACT

A computer system includes a quantum computer, a classical co-processor and an interface that transmits at least part of at least one problem between the quantum computer and the classical co-processor. A digital computer may be coupled to the quantum computer and classical co-processor. Problems may be decomposed for solution by the quantum computer and co-processor based on computational efficiency.

### CROSS REFERENCE TO RELATED APPLICATIONS

This application claims benefit under 35 U.S.C. 119(e) of U.S. Provisional Patent Application Ser. No. 60/943,525, filed Jun. 12, 2007 and entitled “A Method and System for Increasing Quantum Computer Processing Speed Using Digital Co-Processor,” which is incorporated herein by reference in its entirety.

### BACKGROUND OF THE DISCLOSURE

1. Field of the Disclosure

This disclosure generally relates to analog computing and analog processors, for example, quantum computing and quantum processors.

2. Description of the Related Art

A Turing machine is a theoretical computing system, described in 1936 by Alan Turing. A Turing machine that can efficiently simulate any other Turing machine is called a Universal Turing Machine (UTM). The Church-Turing thesis states that any practical computing model has either the equivalent or a subset of the capabilities of a UTM.

A quantum computer is any physical system that harnesses one or more quantum effects to perform a computation. A quantum computer that can efficiently simulate any other quantum computer is called a Universal Quantum Computer (UQC).

In 1981 Richard P. Feynman proposed that quantum computers could be used to solve certain computational problems more efficiently than a UTM and therefore invalidate the Church-Turing thesis. See e.g., Feynman R. P., “Simulating Physics with Computers”, International Journal of Theoretical Physics, Vol. 21 (1982) pp. 467-488. For example, Feynman noted that a quantum computer could be used to simulate certain other quantum systems, allowing exponentially faster calculation of certain properties of the simulated quantum system than is possible using a UTM.

### Approaches to Quantum Computation

There are several general approaches to the design and operation of quantum computers. One such approach is the “circuit model” of quantum computation. In this approach, qubits are acted upon by sequences of logical gates that are the compiled representation of an algorithm. Circuit model quantum computers have several serious barriers to practical implementation. In the circuit model, it is required that qubits remain coherent over time periods much longer than the single-gate time. This requirement arises because circuit model quantum computers require operations that are collectively called quantum error correction in order to operate. Quantum error correction cannot be performed without the circuit model quantum computer's qubits being capable of maintaining quantum coherence over time periods on the order of 1,000 times the single-gate time. Much research has been focused on developing qubits with coherence sufficient to form the basic information units of circuit model quantum computers. See e.g., Shor, P. W. “Introduction to Quantum Algorithms”, arXiv.org:quant-ph/0005003 (2001), pp. 1-27. The art is still hampered by an inability to increase the coherence of qubits to acceptable levels for designing and operating practical circuit model quantum computers.

Another approach to quantum computation, involves using the natural physical evolution of a system of coupled quantum systems as a computational system. This approach does not make critical use of quantum gates and circuits. Instead, starting from a known initial Hamiltonian, it relies upon the guided physical evolution of a system of coupled quantum systems wherein the problem to be solved has been encoded in the terms of the system's Hamiltonian, so that the final state of the system of coupled quantum systems contains information relating to the answer to the problem to be solved. This approach does not require long qubit coherence times. Examples of this type of approach include adiabatic quantum computation, cluster-state quantum computation, one-way quantum computation, quantum annealing and classical annealing, and are described, for example, in Farhi, E. et al., “Quantum Adiabatic Evolution Algorithms versus Stimulated Annealing” arXiv.org:quant-ph/0201031 (2002), pp 1-24.

### Qubits

As mentioned previously, qubits can be used as fundamental units of information for a quantum computer. As with bits in UTMs, qubits can refer to at least two distinct quantities; a qubit can refer to the actual physical device in which information is stored, and it can also refer to the unit of information itself, abstracted away from its physical device.

Qubits generalize the concept of a classical digital bit. A classical information storage device can encode two discrete states, typically labeled “0” and “1”. Physically these two discrete states are represented by two different and distinguishable physical states of the classical information storage device, such as direction or magnitude of magnetic field, current, or voltage, where the quantity encoding the bit state behaves according to the laws of classical physics. A qubit also contains two discrete physical states, which can also be labeled “0” and “1”. Physically these two discrete states are represented by two different and distinguishable physical states of the quantum information storage device, such as direction or magnitude of magnetic field, current, or voltage, where the quantity encoding the bit state behaves according to the laws of quantum physics. If the physical quantity that stores these states behaves quantum mechanically, the device can additionally be placed in a superposition of 0 and 1. That is, the qubit can exist in both a “0” and “1” state at the same time, and so can perform a computation on both states simultaneously. In general, N qubits can be in a superposition of 2^{N} states. Quantum algorithms make use of the superposition property to speed up some computations.

In standard notation, the basis states of a qubit are referred to as the |0 [symbol] and |1 [symbol] states. During quantum computation, the state of a qubit, in general, is a superposition of basis states so that the qubit has a nonzero probability of occupying the |0 [symbol] basis state and a simultaneous nonzero probability of occupying the |1 [symbol] basis state. Mathematically, a superposition of basis states means that the overall state of the qubit, which is denoted |Ψ [symbol] , has the form |Ψ [symbol] =a|0 [symbol] +b|1 [symbol] , where a and b are coefficients corresponding to the probabilities |a|² and |b|², respectively. The coefficients a and b each have real and imaginary components, which allows the phase of the qubit to be characterized. The quantum nature of a qubit is largely derived from its ability to exist in a coherent superposition of basis states and for the state of the qubit to have a phase. A qubit will retain this ability to exist as a coherent superposition of basis states when the qubit is sufficiently isolated from sources of decoherence.

To complete a computation using a qubit, the state of the qubit is measured (i.e., read out). Typically, when a measurement of the qubit is performed, the quantum nature of the qubit is temporarily lost and the superposition of basis states collapses to either the |0 [symbol] basis state or the |1 [symbol] basis state and thus regaining its similarity to a conventional bit. The actual state of the qubit after it has collapsed depends on the probabilities |a|² and |b|² immediately prior to the readout operation.

### Superconducting Qubits

There are many different hardware and software approaches under consideration for use in quantum computers. One hardware approach uses integrated circuits formed of superconducting materials, such as aluminum or niobium. The technologies and processes involved in designing and fabricating superconducting integrated circuits are in some respects similar to those used for conventional integrated circuits.

Superconducting qubits are a type of superconducting device that can be included in a superconducting integrated circuit. Superconducting qubits can be separated into several categories depending on the physical property used to encode information. For example, they may be separated into charge, flux and phase devices, as discussed in, for example Makhlin et al., 2001, Reviews of Modern Physics 73, pp. 357-400. Charge devices store and manipulate information in the charge states of the device, where elementary charges consist of pairs of electrons called Cooper pairs. A Cooper pair has a charge of 2e and consists of two electrons bound together by, for example, a phonon interaction. See e.g., Nielsen and Chuang, Quantum Computation and Quantum Information, Cambridge University Press, Cambridge (2000), pp. 343-345. Flux devices store information in a variable related to the magnetic flux through some part of the device. Phase devices store information in a variable related to the difference in superconducting phase between two regions of the phase device. Recently, hybrid devices using two or more of charge, flux and phase degrees of freedom have been developed. See e.g., U.S. Pat. No. 6,838,694 and U.S. Patent Application No. 2005-0082519.

### BRIEF SUMMARY OF THE DISCLOSURE

In one embodiment, a method of increasing the performance of a quantum computer may be summarized as including receiving a problem, solving the problem with a quantum computer, wherein solving includes decomposing the problem into at least a first subproblem and a second subproblem, transmitting the first subproblem to the quantum computer, determining a first subsolution to the first subproblem, transmitting the second subproblem to a classical co-processor, determining a second subsolution to the second subproblem, and determining a solution to the problem wherein at least the first subsolution and the second subsolution are used to determine the solution; and transmitting the solution from the quantum computer.

In another embodiment, a computer system may be summarized as including a quantum computer, a classical co-processor, and an interface between the quantum computer and the digital co-processor, wherein at least part of at least one problem is transmitted between the quantum computer and the classical co-processor through the interface. The computer system may also include a digital computer communicatively coupled to at least one of the quantum computer and the classical co-processor. The digital computer may transmit a first problem to the quantum computer, and may receive a first solution to the first problem from the classical co-processor.

### BRIEF DESCRIPTION OF THE SEVERAL VIEWS OF THE DRAWINGS

FIGS. 1A, 1B and 1C are functional diagrams showing systems for solving computational problems according to one illustrative embodiment.

FIG. 2 is a flow diagram showing a method for increasing quantum computer processing speed using a digital co-processor.

FIG. 3 is a flow diagram showing a method for increasing quantum computer processing speed using a digital co-processor.

In the figures, identical reference numbers identify similar elements or acts. The sizes and relative positions of elements in the figures are not necessarily drawn to scale. For example, the shapes of various elements and angles are not drawn to scale, and some of these elements are arbitrarily enlarged and positioned to improve legibility. Further, the particular shapes of the elements as drawn are not intended to convey any information regarding the actual shape of the particular elements and have been solely selected for ease of recognition in the figures. Furthermore, while the figures may show specific layouts, one skilled in the art will appreciate that variations in design, layout, and fabrication are possible and the shown layouts are not to be construed as limiting the geometry of the present systems, devices, and methods.

### DETAILED DESCRIPTION OF THE DISCLOSURE

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with analog processors, digital processors, memory structures, busses and/or computers have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

There is a long tradition in the computing industry of augmenting central processors of powerful computing systems with specialized co-processors optimized to perform certain tasks more efficiently than central processor can do. For example, large mainframes and supercomputers have input/output (I/O) co-processors to deal with user interaction and storage media access. Some operations are delegated by the large mainframes and supercomputer to less powerful, more cost efficient, special purpose hardware.

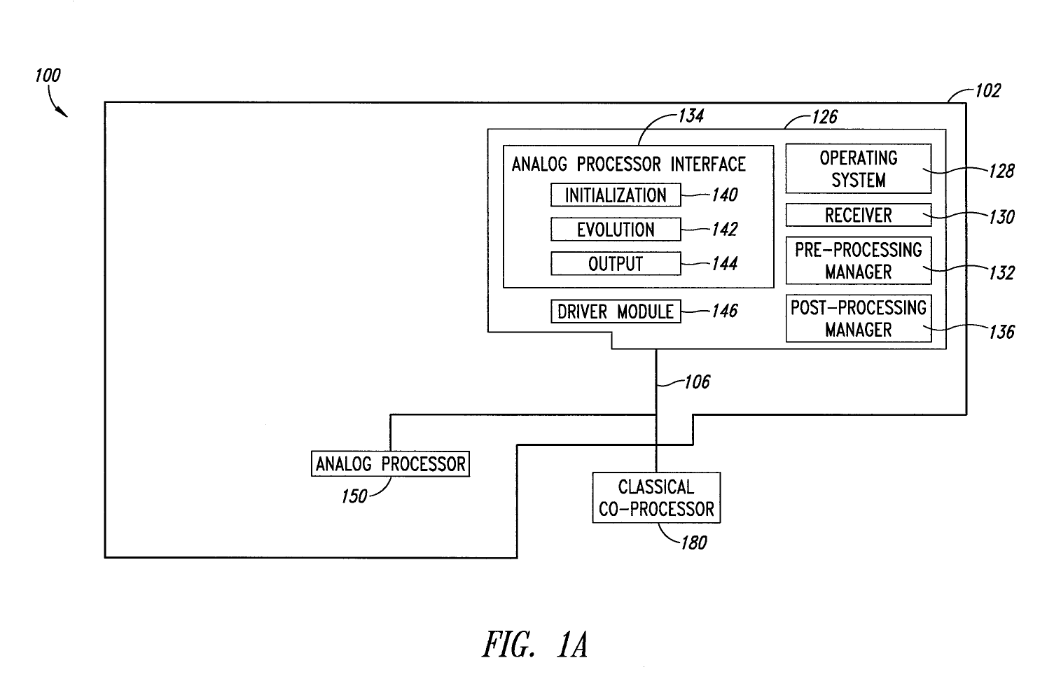

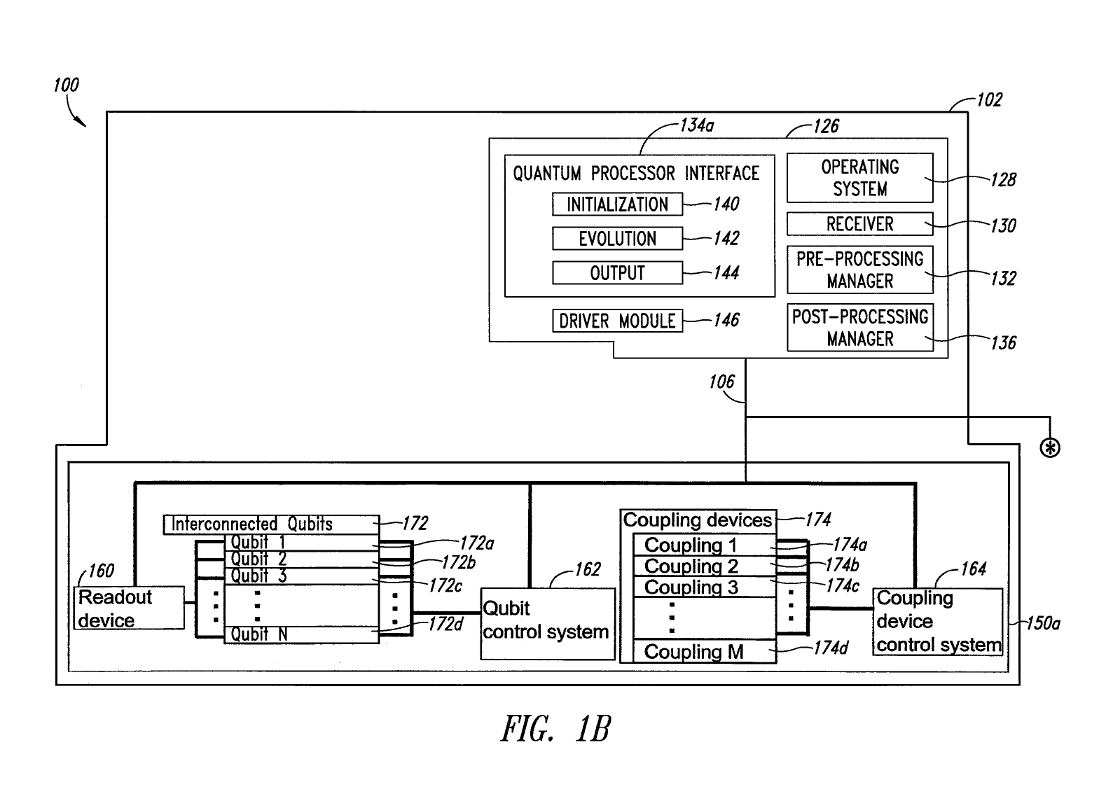

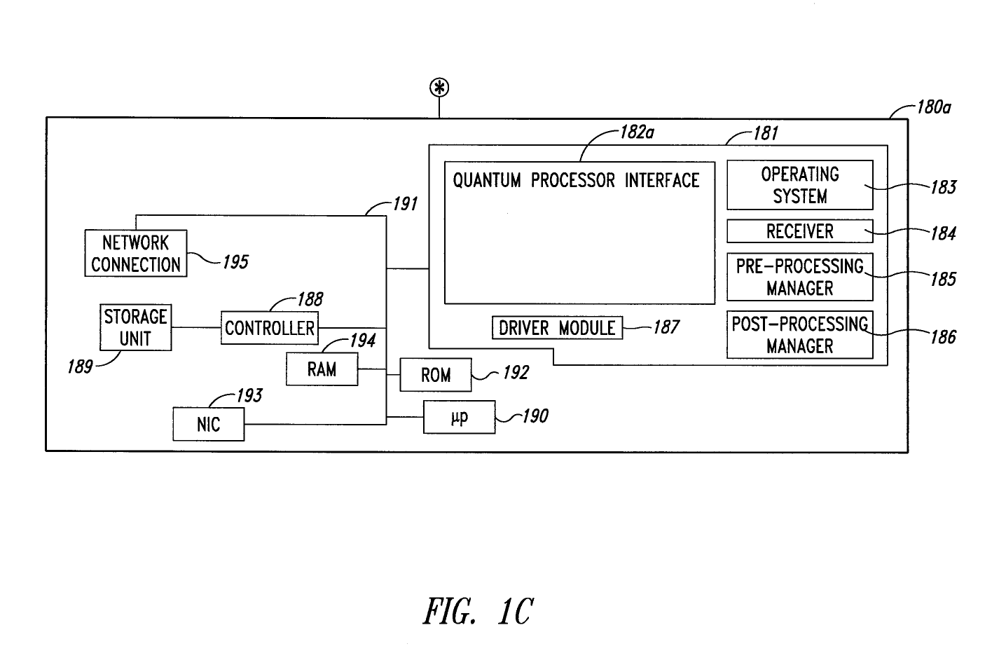

FIG. 1A shows an exemplary problem-solving system 100. The problem-solving system 100 may include an analog computer 102 having an analog processor 150 and in communication with a classical co-processor 180. An analog processor is a processor that employs the fundamental properties of a physical system to find the solution to a computation problem. In contrast to a digital processor, which requires an algorithm for finding the solution followed by the execution of each step in the algorithm according to Boolean methods, analog processors do not involve Boolean methods. If analog processor 150 determines that Boolean methods are required to solve a subproblem efficiently, the subproblem may be sent from the quantum processor to classical co-processor 180 where Boolean logic problems are efficiently solved. Classical co-processor 180 may solve the subproblem and return the solution (referred to herein and in the claims as a subsolution) of the subproblem to analog processor 150. Classical algorithms or heuristics may be solved on classical co-processor 180 and solutions or subsolutions to the classical algorithms or heuristics may be used to solve quantum algorithms or heuristics on analog processor 150.

Computer 102 may include analog processor 150, classical co-processors 180, and the like. Computer 102 may further include one or more memories 126 coupled to processors 150, 180 by one or more busses 106. Examples of the one or more memories include a system memory 126, such as high speed random-access memory (RAM), for storing system control programs (e.g., operating system 128, application programs loaded from main non-volatile storage unit, data, and the like), a read-only memory (ROM), and quantum flux memory modules, such as is discussed in U.S. Ser. No. 11/950,276.

Computer 102 may include an operating system 128 for handling various system services, such as file services, and for performing hardware dependent tasks. Examples of operating system 128 include UNIX, Windows NT, Windows XP, DOS, LINUX, VMX, and the like but may also include a customized operating system specialized for the task of operating an analog processor. Alternatively, no operating system 128 may be present and instructions may be executed on “bare hardware” where no operating system is used to coordinate processing requests.

Analog processor 150 may take the form of the quantum processor 150a shown in FIG. 1B, including a plurality of qubits 172a-172d (collectively 172) partitioned into qubit nodes, a plurality of coupling devices 174a-174d (collectively 174), a readout device 160, a qubit control system 162, and a coupling device control system 164. Quantum processor 150a may include at least two qubits 172 and at least one coupling device 174.

Qubit nodes 172 serve as the basis for performing quantum computation, and may take the form of superconducting qubits. Examples of qubits include quantum particles, atoms, electrons, photons, ions, and the like. Typical superconducting qubits, for example, have the advantage of scalability and are generally classified depending on the physical properties used to encode information including, for example, charge and phase devices, phase or flux devices, hybrid devices, and the like.

Readout device 160 may include a plurality of dc-SQUID magnetometers, each inductively connected to a different qubit within interconnected topology of qubits 172. The dc-SQUID magnetometers including a loop of superconducting material interrupted by at least one Josephson junctions are well known in the art.

Qubit control system 162 may include one or more controllers for interconnected topology of qubits 172. Coupling device control system 164 may include one or more coupling controllers for coupling devices 174. Each respective coupling controller in coupling device control system 164 may be configured to tune the coupling strength of a corresponding coupling device 174a-174d from zero to a maximum value. Coupling devices 174 may be tuned, for example, to provide ferromagnetic or anti-ferromagnetic coupling between qubits 172.

Problem solving system 100 may further include at least one classical co-processor 180. Classical co-processor 180 may take the form of digital co-processor 180a shown in FIG. 1C including a driver module 187 configured to output signals to quantum processor 150a, a non-volatile storage controller 188, a non-volatile storage unit 189, one or more microprocessors 190, internal buses 191, read-only memory 192, a IC 193, and system memory 181 storing a computer program product which may include aspects of the quantum processor interface 182a, operating system 183, receiver 184, pre-processing manager 185, post-processing manager 186 and the like. Quantum processor interface 182a may be configured to convert the computational problem processing request into a series of instructions receivable by quantum processor 150a, to obtain a sub-problem from the computational problem processing request currently being processed by quantum processor 150a, and/or to send a solution or subsolution of the computational problem.

Operating system 183 of digital co-processor 180a may handle various system services, such as file services, and for performing hardware dependent tasks.

Receiver 184 may be configured to receive problems to be solved on quantum processor 150a. Receiver 184 may further be configured to send a response to a computational problem processing request.

Pre-processing manager 185 may be configured to convert computational problems generated by digital co-processor 180a into a series of instructions for quantum processor 150a.

Post-processing manager 186 may be configured to convert solutions to computational problems found by classical co-processor 180a into a series of instructions for quantum processor 150a. Post-processing manager 186 may also be configured to return solutions to computational problems found by classical co-processor 180a to computer 102.

IC 193 may be configured to send such commands to qubit control system 162 and coupling device control system 164.

Quantum processor 150a may be in direct communication with the digital co-processor 180a such that the quantum processor 150a can make calls to the digital co-processor 180a through a network connection 195 to solve subproblems and computational tasks which are at least one of more cost efficiently and/or more time efficiently solved on digital co-processor 180a or microprocessors 190. Network connection 195 may just allow for communication between all systems within problem solving system 100.

There may be more than one digital co-processor 180a such that each classical co-processor in the problem-solving system 100 may be in communication with quantum processor 150a. There may be a plurality of digital co-processors 180a in problem solving system 100 such that quantum processor 150a addresses the plurality of digital co-processor 180a as a single computer and within the plurality of digital co-processor 180a problems are divided between many digital processors to maximize at least one of cost efficiency and time efficiency. The solution to the tasks sent to digital co-processor 180a may be returned directly to quantum processor 150a.

With continuing reference to FIG. 1A, problem-solving system 100 may further include a number of programs and data structures. Typically, some or all of the data structures and programs may be stored in one or more memories including system memory 126 and the like. Such may include storing information regarding at least one of: a coupling state corresponding to at least one of the controllable coupling devices or an initial basis state corresponding to at least one of the quantum devices. Likewise these programs and data structures or information may be processed using analog processors 150, classical co-processor 180, and the like. For ease of presenting the various features and advantages of the present systems, devices, and methods, however, such data structures, and programs are drawn as components of system memory 126. It will be appreciated, however, that at any given time the programs and data structures illustrated in system memory 126 or other information (e.g., information regarding at least one of: a coupling state corresponding to at least one of the controllable coupling devices or an initial basis state corresponding to at least one of the quantum devices) may be stored, for example, in non-volatile storage unit. In some embodiments, some or all of the data structures and programs may be stored on one or more remote computers not illustrated in FIG. 1A, provided that the one or more remote computers are addressable by computer 102, i.e., that there is some communication between the remote computer and computer 102 such that data can be exchanged among computers over, for example, a data network (e.g., a serial connection, a parallel connection, Ethernet, and the like) using a communication protocol (e.g., the Internet, FTP, telnet, SSH, a custom IP-based protocol, bus 106 and the like). In some other embodiments, some or all of the data structures and programs may be redundantly stored and/or processed on one or more remote computers (not shown), provided that the one or more remote computers are addressable by computer 102.

Problem-solving system 100 may further include a receiver 130, a pre-processing manager 132, an analog processor interface 134 such as a quantum processor interface 134a (FIG. 1B), and a post-processing manager 136. Receiver 130 may be configured to receive problems to be solved on analog processor 150 or from an external computing system. Receiver 130 may further be configured to send a response to a computational problem processing request.

In an embodiment, receiver 130, pre-processing manager 132, quantum processor interface 134a and post-processing manager 136 are all implemented in one or more digital computing systems or within the analog processor. In another embodiment, at least one of receiver 130, pre-processing manager 132, quantum processor interface 134a, and post-processing manager 136 may be in a location remote from quantum processor 150a.

Analog processor 150 may be operable to produce one or more solutions to computational problems identified by the computational problem processing requests. In some embodiments, analog processor 150 may be operable to obtain one or more solutions to the computational problems or subsolutions to subproblems via a physical evolution of the analog processor. In another embodiment, problem-solving system 100 may include additional analog processors 150 and additional classical co-processors 180 operable to redundantly co-process one or more solutions or subsolutions of computational problems or subproblems identified by the computational problem processing requests.

A computational problem may be received by problem-solving system 100 via a telephone modem, a wireless modem, a local area network connection, a wide area network connection, a portable digital data device, and the like. The information received by the receiver 130 may include initial values of couplings between qubits 172, local bias of qubits 172, run-time control parameters, and the like. Alternatively, the information received by receiver 130 may include a graph that represents a computational problem, macro-language instructions, such as AMPL, that define a computational problem, and the like.

Receiver 130 may be operable to provide instructions for scheduling a computation, as well as acquiring the solution to the problem. In an embodiment, a solution of the computation is collected as an output from quantum processor 150a. In another embodiment, receiver 130 may optionally include a graphical user interface (GUI), Command Line Interfaces (CLI), Text User Interface (TUI), and the like. In another embodiment, receiver 130 is operable to receive graphical representations of the computational problem.

Pre-processing manager 132 may be configured to receive the computational problem processing request from receiver 130, and convert the computational problem processing requests into a first series of instructions. Pre-processing manager 132 may further be configured for determining a first Hamiltonian. In an embodiment, pre-processing manager 132 is configured for mapping a computational problem or subproblem into a problem or subproblem of an equivalent complexity class. In another embodiment, pre-processing manager 132 includes logic to map the computational problem or subproblem into at least one of a problem or subproblem of equivalent, greater or lesser complexity class. In an embodiment, the logic to map the computational problem or subproblem onto analog processor 150 includes instructions for mapping the computational problem or subproblem onto a topological representation and embedding the topological representation onto analog processor 150. In an embodiment, the topological representation is in a form of at least one of a planar graph or a non-planar graph. In another embodiment, the topological representation is a graph in the form of a plurality of vertices, and one or more edges. In another embodiment, the topological representation is an interconnected graph of the same structure had by the interconnected topology of qubits 172.

In another embodiment, pre-processing manager 132 is configured for mapping a computational problem or subproblem onto the analog processor 150, for example, the quantum processor 150a. Mapping a computational problem or subproblem onto the analog processor 150 may include, for example, mapping the computational problem or subproblem onto a graph and embedding the graph onto the analog processor 150.

The quantum processor interface 134a may be operable to receive a first series of instructions from the pre-processing manager 132. Quantum processor 150a may be configured to receive a second series of instructions from quantum processor interface 134a, and obtain a solution or subsolution of the computational problem or subproblem processing request by a physical evolution of the analog processor. Post-processing manager 136 may be configured to convert the solution or subsolution into a post-processed solution.

Pre-processing manager 132 may include a mapper interface configured to map a computational problem or subproblem to be solved into a corresponding problem description or subproblem description that is solvable by analog processor 150. The mapper interface may be configured to map problems or subproblems from one graphical representation into a target graphical representation required for a specific configuration of analog processor 150. In an embodiment, the target graphical representation may include an interconnected topology, analog processor 150 may take the form of a quantum processor 150a that may include a lattice of qubits 172 and coupling devices 174, and each coupling device 174 may be configured to couple two qubits 172 together.

The mapper interface may be configured to map some NP problems (e.g., a mathematical problem such as Maximum Independent Set, Max Clique, Max Cut or k-SAT, or a problem such as an integer programming problem, a constraint optimization problem, a factoring problem, a prediction modeling problem, an operations research problem, a financial portfolio selection problem, a scheduling problem, a supply management problem, a circuit design problem, a travel route optimization problem, a business process simulation problem, an ecological habitat simulation problem, a protein folding simulation problem, a molecular ground state simulation problem or a quantum system simulation problem, and the like) into another NP problem, such as the Ising Spin Glass problem or other problems already mentioned.

Once the target graphical representation needed to solve a desired problem or subproblem has been mapped by the mapper interface, quantum processor interface 134a is used to set up the coupling values and local bias values for coupling devices 174 and interconnected qubits 172 in order to map the representation onto the quantum processor 150a. In an embodiment, three discrete program modules may provide the functions of quantum processor interface 134a (FIG. 1B): an initialization module 140, an evolution module 142, and an output module 144.

Initialization module 140 may be configured to determine the appropriate values of coupling Jᵢⱼ for coupling devices 174 and values of local bias hᵢ for the interconnected qubits 172. Initialization module 140 may be configured to convert aspects of a problem definition into physical values, such as coupling strength values and qubit bias values, which can be programmed into quantum processor 150a. Initialization module 140 may then be configured to send the appropriate signals along one or more internal buses 106. Buses 106, in turn, may be configured to send such commands to qubit control system 162 and coupling device control system 164.

For any given problem or subproblem, evolution module 142 may be configured to determine the appropriate values, at each point in time for the duration of the computation, of coupling Jᵢⱼ for coupling devices 174 and values of local bias hᵢ for interconnected qubits 172 to fulfill some predetermined evolution schedule (i.e., the schedule for how the evolution is to take place). Once determined, the appropriate coupling device values and local bias values for an evolution schedule are sent as signals via one or more buses 106. Buses 106 may be is configured to send such commands to quantum device control system 162 and coupling device control system 164.

The computation of analog processor 150 may be configured to operate as, for example, an adiabatic evolution or an annealing evolution. An adiabatic evolution is the evolution used in adiabatic analog computing, and evolution module 142 may be configured to evolve the state of the analog processor 150 in accordance with the evolution used in adiabatic quantum computation. See, e.g., U.S. Patent Publication Numbers 2005-0256007 and 2005-0250651, and U.S. Pat. No. 7,135,701 each titled “Adiabatic Quantum Computation with Superconducting Qubits.” Annealing is another form of evolution applicable to some analog processors 150, and evolution module 142 may be configured to evolve the state of analog processor 150 in accordance with annealing evolution.

Quantum processor 150a may be configured to solve a quantum problem or subproblem based on signals provided by initialization module 140 and evolution module 142. Once the problem or subproblem has been solved, the solution to the problem or subproblem may be measured from the states of interconnected qubits 172 by readout device 160. Output module 144 may be configured in conjunction with readout device 160 to read this solution or subsolution.

The computation of analog processor 150 may be configured to operate in a manner such that when analog processor 150 receives a problem which is comprised of at least one subproblem that is inefficiently solved on analog processor 150, the subproblem is sent to classical co-processor 180. Classical co-processor 180 receives the subproblem, solves the subproblem, and returns a solution of the subproblem to analog processor 150.

System memory 126 may further include a driver module 146 configured to output signals to analog processor 150. Bus 106 may be configured to interface with interconnected qubits 172 and coupling devices 174, either directly or through readout device 160, qubit control system 162, and/or coupling device control system 164. Alternatively, bus 106 may include software and/or hardware that translates commands from driver module 146 into signals (e.g., voltages, currents) that are directly applied to interconnected qubits 172 and coupling devices 174. In an embodiment, bus 106 may include software and/or hardware for translating signals (representing a solution to a problem, subsolution to a subproblem or some other form of feedback) from interconnected qubits 172 and coupling devices 174 such that output module 144 can interpret them. In some embodiments, initialization module 140, evolution module 142, and/or output module 144 may communicate with driver module 146, rather than directly with bus 106, to send and receive signals from analog processor 150 and classical co-processor 180.

The functionality of bus 106 can be divided into two classes: data acquisition and control. Data acquisition is used to measure physical properties of interconnected qubits 172 after quantum processor 150a has completed a computation. Such data can be measured using any number of customized or commercially available data acquisition micro-controllers including data acquisition cards manufactured by Elan Digital Systems (Fareham, UK) including the AD132, AD136, MF232, MF236, AD142, AD218, CF241 cards, and the like. Alternatively, a single type of microprocessor, such as the Elan D403C or D480C, may handle data acquisition and control.

Computer 102 may further be configured for receiving a computational problem or subproblem and transmitting the solution or subsolution of a computational problem processed by analog processor 150 to another system such as classical co-processor 180, such as via a telephone modem, a wireless modem, a local area network (LAN) connection, a wide area network (WAN) connection, a portable digital data device, and the like. Computer 102 may be configured to generate a carrier wave embodying a data signal, with the solution to the computational problem processed by analog processor 150 and classical co-processor 180 embedded therein.

Analog processor 150 may be in the form of a superconducting quantum computer, examples of which include qubit registers, readout devices, and ancillary devices. Superconducting quantum computers normally are operated at milliKelvin temperatures and often are operated in a dilution refrigerator. An example of a dilution refrigerator is the Leiden Cryogenics B.V. MNK 126 series (Galgewater No. 21, 2311 VZ Leiden, The Netherlands). All or part of the components of the quantum processor 150a may be housed in a dilution refrigerator. For example, qubit control system 162 and coupling device control system 164 may be housed outside a dilution refrigerator with the remaining components of quantum processor 150a being housed inside a dilution refrigerator.

Receiver 130, quantum processor interface 134a, and driver module 146, or any combination thereof, may be implemented via existing software packages. Suitable software packages include, for example, MATLAB (The MathWorks, Natick, Mass.), LabVIEW (National Instruments, Austin, Tex.), Maple (Waterloo Maple Inc., Waterloo, Ontario, Canada.), Mathematica (Wolfram Research, Inc., Champaign, Ill.), and the like.

In an embodiment, receiver 130 may be configured to receive a computational problem or subproblem processing request, and to provide identity information indicative of an entity responsible for the received computational problem or subproblem processing request.

In an embodiment, the present systems, devices, and methods may be implemented as a computer program product that includes a computer program mechanism embedded in a computer readable storage medium. For example, the computer program product may include aspects of the quantum processor interface 134a, operating system 128, receiver 130, pre-processing manager 132, post-processing manager 136 and the like. Aspects of the various interfaces, managers, and modules, may be stored on a CD-ROM, DVD, magnetic disk storage product, any other computer readable data or program storage product, and may also be distributed electronically, via the Internet or otherwise, by transmission of a computer data signal (in which the software modules are embedded) embodied in a carrier wave, and the like.

In an embodiment, the problem-solving system 100 may include a receiver 130, a pre-processing manager 136 and a quantum processor interface 134a. Receiver 130 may be configured to receive a computational problem or subproblem processing request and provide identity information indicative of an entity responsible for the received computational problem or subproblem processing request. The quantum processor interface 134a may be configured to convert the computational problem or subproblem processing request into a series of instructions receivable by the quantum processor 150a, to obtain a solution or subsolution of the computational problem or subproblem processing request, and/or to send a solution or subsolution of the computational problem or subproblem.

In other embodiments, problem-solving system 100 may include additional digital co-processors 180 configured to store execution data including processing variables, solution parameters, simulation trajectories, checkpoints, and the like throughout the processing of a computational problem processing request.

Quantum computers are more powerful than their classical counterparts at certain computational applications. They are, however, more expensive and, by virtue of their quantum behaviour, very poorly suited for interaction with classical world in which the quantum computers' users input problems from and receive answers in. Thus, to operate efficiently quantum computers may benefit by operating with a classical I/O co-processor for such tasks as accepting user requests for computation, formatting the requests to a form suitable for the quantum computer execute, buffering and stitching together answers provided by QC, formatting a final answer into a form receivable by users and returning the final answer to the user.

Quantum computers may be capable of solving larger multi-variable and complex problems by utilizing classical co-processors than would be solvable with quantum computer hardware alone. Some problems which may be solved on quantum computers are such that the resources required to represent all variables within the problem are too demanding for available quantum computer hardware. By creating a subproblem in which variables are solved for by a classical co-processor, the problem that the quantum computer subsequently solves can be of a manageable size for the quantum hardware.

Some straightforward computational tasks completed during quantum computation are more efficiently done by a classical processor. For example, some quantum algorithms for discrete optimization call for repeated verification and grading of produced answers to find the most accurate answer. These operations are usually straightforward evaluation of some formula that does not require quantum parallelism and can easily be dispatched by a quantum computer to a classical co-processor. By utilizing classical co-processors to offload straightforward computational tasks from the quantum computer, the speed at which problems tasked to the quantum computer will be solved more timely and cost efficiently.

When considering real-world processing systems, error checking and correction must be considered. One approach to error correction is to produce and buffer several solutions of the same problem and compare all solutions produced to determine which solution was produced most commonly; if all answers disagree with each other or there is no most-common answer, computation can be re-started. A quantum processor can relegate this buffering and comparison task to its classical counterpart.

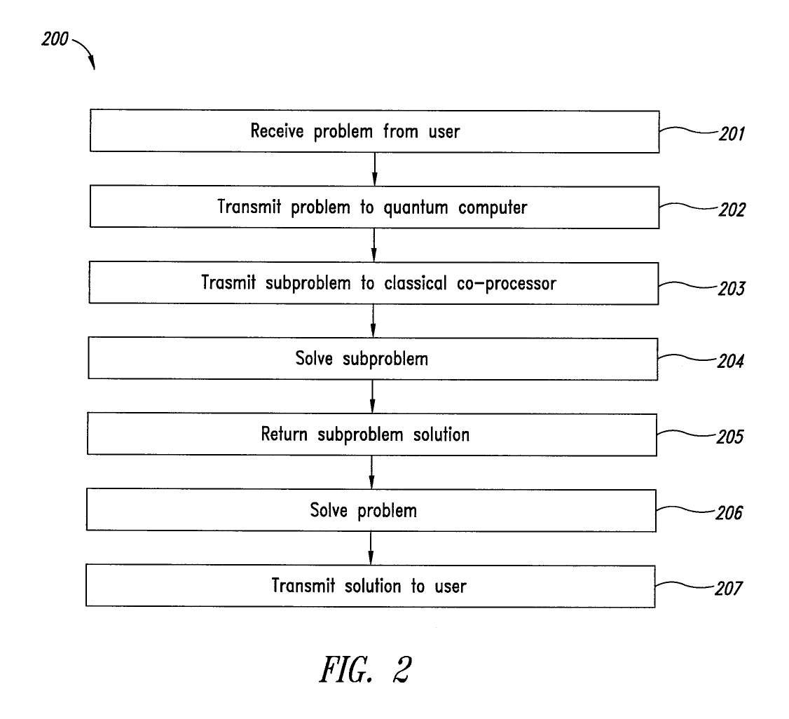

FIG. 2 is a flow diagram showing a method 200 for increasing quantum computer processing speed using a digital co-processor. The method 200 may be performed by, for example, the problem solving system 100 of FIGS. 1A-1C. In other embodiments the method 200 may be performed by a quantum computer which is in communicative contact with at least one classical co-processor capable of solving subproblems related to the problem being solved by the quantum computer.

The method 200 starts at 201 with a problem solving system receiving a problem from a user. The problem may be received by a receiver 130 which is communicatively coupled to a computer operated by the user. The problem may be any problem the quantum computer is capable of solving with or without the use of a classical co-processor including optimization problems, such as logistics, planning, network utilization, etc., constraint satisfaction problems such as scheduling and configuration management, etc., and other types of problems.

At 202, the problem may then be transmitted to the quantum computer. The pre-processing manager 132 may have received the computational problem processing request from the receiver 130, and converted the computational problem processing requests into instructions and transmitted the instructions to the quantum computer through a means such as an bus 106.

At 203, the quantum computer may then determine that a portion of the instructions received are efficiently solved by a classical co-processor which is communicatively coupled to the quantum computer. The quantum computer would then transmit a subproblem, corresponding to the portion of instructions received which are efficiently solved by the classical co-processor, to the classical co-processor, where the classical co-processor would solve the subproblem at 204. The quantum computer may partially solve the problem before sending subproblems to classical co-processors and may continuously send tasks to classical co-processors throughout the computation required to solve the problem.

One of skill in the art would appreciate that the pre-processing manager 132 may determine that a portion of the instructions received are efficiently solved by a classical co-processor which is communicatively coupled to the quantum computer. The pre-processing manager 132 may convert the computational problem processing requests into instructions for at least two subproblems, a first subproblem executable on a quantum processor and a second subproblem executable on a classical co-processor, transmit the instructions to the first subproblem to the quantum computer through a means such as bus 106 and transmit the instructions to the second subproblem to the classical co-processor through a means such as bus 106. The results of attempts to solve the subproblems may be denominated as subsolutions.

At 205, the classical co-processor would transmit the subsolution to the subproblem it solved in 204 back to the quantum computer to which it is communicatively coupled. The computational subproblems solved by the classical co-processors may be transmitted to some part of the problem solving system other than the quantum computer. There may be several classical co-processors communicatively coupled to the quantum computer where each classical co-processor may be specifically designated or designed to solve certain subproblems. There may be several classical co-processors communicatively coupled to the quantum computer which are specifically designed, designated or programmed to solve the same subproblem. The classical co-processors which are designed or designated to solve the same subproblem may operate to solve one subproblem at a time. The classical co-processors which are designed or designated to solve the same subproblem may operate in parallel to solve several unrelated subproblems at a time. In some embodiments, two or more subsolutions may be combined to create or define a new or additional subproblem. The new or additional subproblem may, for example, be a subproblem of the problem.

At 206, the quantum computer solves the problem. The subsolutions to the subproblems which the quantum computer had tasked with the solving are incorporated here. The solution or subsolution found by the quantum computer may be sent to some part of the problem solving system to be incorporated with subsolutions from the classical co-processors to produce the solution. The post-processing manager 136 may convert the solution into a post-processed solution which is, at 207, returned to the user.

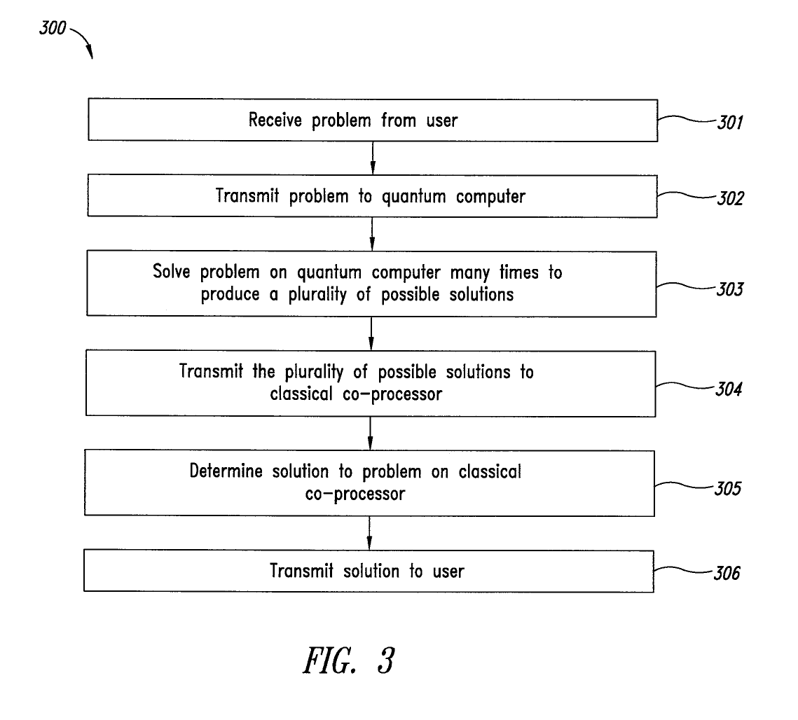

FIG. 3 is a flow diagram showing a method 300 for increasing quantum computer processing speed using a digital co-processor. The method 300 may be performed by, for example, the problem solving system 100 of FIGS. 1A-1C. In other embodiments the method 300 may be performed by a quantum computer which is in communicative contact with at least one classical co-processor capable of solving subproblems related to the problem being solved by the quantum computer.

The method 300 starts at 301 with a problem solving system receiving a problem from a user. The problem may be received by a receiver 130 which is communicatively coupled to a computer operated by the user. The problem may be any problem the quantum computer is capable of solving with or without the use of a classical co-processor including optimization problems, such as logistics, planning, network utilization, etc., constraint satisfaction problems such as scheduling and configuration management, etc., and to other types of problems.

At 302, the problem may then be transmitted to the quantum computer. The pre-processing manager 132 may have received the computational problem processing request from the receiver 130, and converted the computational problem processing requests into instructions and transmitted the instructions to the quantum computer through a means such as bus 106.

At 303, the problem may be solved in a manner similar to that outlined in FIG. 2. The problem may also not use classical co-processors during calculation of the possible solution. This act may be run many times. The number of times 303 is completed may be predetermined by the user or the number of times 303 is run may be dependant upon the length of time allotted to solve a given problem.

At 304, each possible solution or subsolution calculated by the quantum computer in 303 may be transmitted to a classical co-processor which is communicatively coupled to the quantum computer. The classical co-processor stores each possible solution or subsolution in a memory which is communicatively coupled to the classical co-processor.

At 305, the classical co-processor examines the possible solutions or subsolutions produced by the quantum computer in 303 and determines the solution to the problem. This determination may be based upon the number of times a certain solution or subsolution was calculated.

At 306, the solution to the problem may be transmitted to the user. The post-processing manager 136 may convert the solution into a post-processed solution which is, at 207, returned to the user.

The current system may, in some embodiments, consist of a quantum processor and a number of digital or classical co-processors, each of which might be a full-fledged digital computing system such as a desktop computer, a workstation computer, a supercomputing mainframe and the like. A quantum processor, within the quantum computer, upon booting up starts polling, via its classical communication channels, its input co-processors for tasks compiled and ready to be run on quantum hardware. If such a task is received, it is executed and results are dispatched to a digital co-processor for verification. In some embodiments the program is executed several times to provide for error correction. Each result calculated by the quantum computer or a digital co-processor may be stored in a second digital co-processor where all results can be compared to determine which results is the answer to the problem provided to the quantum computer. The most commonly produced result may be returned to the user through a further digital co-processor as the solution to their problem posed to the quantum computer.

In some embodiments, intermediate results are dispatched to classical computational co-processors and results of such classical subroutine calls may be used to alter the course of further quantum computation. Error correcting and result-evaluating co-processors are instructed to inform the quantum processor when a sufficiently good answer is achieved, which marks the completion of given quantum computation task—the results are sent to output classical co-processor for formatting according to end user preferences and sent back to the user.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other computing systems, not necessarily the illustrated computer systems generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, some aspects of the present subject matter may be implemented via Application Specific Integrated Circuits (ASICs). However, those skilled in the art will recognize that the embodiments disclosed herein, in whole or in part, can be equivalently implemented in integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that some of the mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

We/I claim:

1. A method of solving problems with a quantum computer, the method comprising:
receiving a problem on the quantum computer;
decomposing the problem into at least a first subproblem and a second subproblem;
determining a first subsolution to the first subproblem on the quantum computer;
transmitting the second subproblem to a classical co-processor;
determining a second subsolution to the second subproblem; and
determining a solution to the problem wherein at least the first subsolution and the second subsolution are used to determine the solution.

2. The method of claim 1 wherein receiving the problem includes receiving the problem through a user interface.

3. The method of claim 1 wherein decomposing the problem includes decomposing the problem by a pre-processing manager.

4. The method of claim 1, further comprising:
creating a third subproblem;
transmitting the third subproblem to the classical co-processor; and
determining a third subsolution to the third subproblem.

5. The method of claim 4 wherein the third subsolution is used to determine the solution.

6. The method of claim 4 wherein the first subsolution and the second subsolution are combined to create the third subproblem.

7. The method of claim 4 wherein the third subproblem is a subproblem of the problem.

8. The method of claim 4, further comprising:
creating a fourth subproblem; and
determining a fourth subsolution to the fourth subproblem.

9. The method of claim 8 wherein the fourth subsolution is used to determine the solution.

10. The method of claim 6 wherein the first subsolution and the second subsolution are combined to create the third subproblem.

11. The method of claim 6 wherein the third subproblem is a subproblem of the problem.

12. The method of claim 1 wherein determining a first subsolution includes determining the first subsolution using a quantum co-processor.

13. The method of claim 1 wherein determining a second subsolution includes determining the second subsolution using a classical co-processor.

14. The method of claim 1, further comprising:
transmitting the second subsolution to the quantum computer.

15. The method of claim 14 wherein determining a first subsolution occurs after transmitting the second subsolution to the quantum computer.

16. The method of claim 14 wherein transmitting the second subsolution to the quantum computer includes transmitting the second subsolution to the quantum computer from the classical co-processor.

17. The method of claim 14 wherein transmitting the second subsolution to the quantum computer includes transmitting the second subsolution to a digital computer communicatively coupled to the quantum computer and communicatively coupled to the classical co-processor and transmitting the second subsolution to the quantum computer from the digital computer.

18. A computer system, comprising:
a quantum computer;
a classical co-processor; and
an interface between the quantum computer and the digital co-processor, wherein at least part of at least one problem is transmitted between the quantum computer and the classical co-processor through the interface.

19. The computer system of claim 18, further comprising:
a digital computer communicatively coupled to at least one of the quantum computer and the classical co-processor.

20. The computer system of claim 19 wherein the digital computer transmits a first problem to the quantum computer, and wherein the digital computer receives a first solution to the first problem from the classical co-processor.

21. The computer system of claim 20 wherein the at least part of at least one problem is a subproblem of the first problem, and wherein the subproblem is transmitted between the quantum computer and the classical co-processor to reduce the time needed to find the first solution.

22. The computer system of claim 20 wherein the digital computer transmits a second problem to the quantum computer, and wherein the digital computer receives a second solution to the second problem from the quantum computer.

23. The computer system of claim 22 wherein the at least part of at least one problem is a subproblem of the second problem, and wherein the subproblem is transmitted between the quantum computer and the classical co-processor to reduce the time needed to find the first solution.

24. The computer system of claim 18 wherein the at least part of at least one problem is transmitted from the quantum computer to the classical co-processor.

25. The computer system of claim 24 wherein a solution to the at least part of at least one problem is transmitted from the classical co-processor to the quantum computer.

26. The computer system of claim 24 wherein a solution of the at least part of at least one problem is transmitted from the classical co-processor to a digital computer communicatively coupled to the classical co-processor.

27. The computer system of claim 24 wherein the at least part of at least one problem is a plurality of possible solutions, and wherein the classical co-processor determines which of the possible solutions is the solution to the at least part of at least one problem.

28. The computer system of claim 24 wherein the at least part of at least one problem is efficiently solved as a Boolean logic problem.

29. The computer system of claim 18 wherein the quantum computer is a computing system comprising:
a plurality of qubits; and
a plurality of couplers, wherein each coupler couples one of the qubits to another one of the qubits.

30. The computer system of claim 29 wherein each of the qubits is a superconducting qubit and the quantum computer is a superconducting quantum computer.

31. The computer system of claim 18 wherein the classical co-processor comprises a plurality of digital co-processors.
